(19) United States
(12) Patent Application Publication
(10) Pub. No.: US 2008/0244264 A1
(43) Pub. Date: Oct. 2, 2008

(54) PUBLIC KEY CERTIFICATE VALIDATION SYSTEM

(75) Inventors: Katsuyuki UMEZAWA, Machida (JP); Ken Kobayashi, Machida (JP); Kazuyoshi Hoshino, Tokyo (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/040,589

(22) Filed: Feb. 29, 2008

(30) Foreign Application Priority Data
Mar. 28, 2007 (JP) 2007-083270

(51) Int. Cl. H04L 9/32

(52) U.S. Cl. 713/158

(57) ABSTRACT

To validate a certificate of a service provider apparatus, a service receiving apparatus determines a certificate validation method on based on a combination of the performance of the service receiving apparatus, the performance of a CRL repository apparatus, the performance of a certificate validation apparatus, and the performance of a network, and performs validation of a certificate by the determined method. Furthermore, to validate a certificate of a service provider apparatus, a service receiving apparatus requests a method selection apparatus to validate the certificate, and the method selection apparatus determines a certificate validation method based on a combination of the performance of the method selection apparatus, the performance of the CRL repository apparatus, the performance of the certificate validation apparatus and the performance of the network, validates the certificate by the determined method, and notifies a validation result to the service receiving apparatus.

This application claims priority based on the Japanese Patent Application No. 2007-083270 filed on Mar. 28, 2007, the entire content of which is hereby incorporated by reference.

### BACKGROUND

The present invention relates to a public key certificate validation system, and particularly to a public key certificate validation system and method in which a method of validating a public key certificate is changed depending on environmental parameters.

There exist a plurality of public key certificate validation methods, for example, known methods such as a method using a Certificate Revocation List (CRL) (for example, R. Housley, T. Polk, W. Ford and D. Solo, “RFC 3280—Internet X.509 Public Key Infrastructure Certificate and Certificate Revocation List (CRL) Profile”, The Internet Engineering Task Force, 2002 April, URL: http://www.ietf.org/rfc/rfc3280.txt, referred to as Document 1), a method using an Online Certificate Status Protocol (OCSP) (for example, M. Myers, R. Ankney, A. Malpani, S. Galperin and C. Adams, “RFC 2560—X.509 Internet Public Key Infrastructure—Online Certificate Status Protocol—OCSP”, The Internet Engineering Task Force, 1999 June, URL: http://www.ietf.org/rfc/rfc2560.txt, referred to as Document 2), and a method using a certificate validation apparatus (CVS) (for example, Japanese Unexamined Patent Application Laid-Open No. 2002-72876, referred to as Document 3). These methods can be used by a portable service receiving apparatus in a radio communication environment.

Validation time for these methods is influenced by environment such as network performance and service receiving apparatus performance. Thus, a method is known in which a theoretical equation for expressing the validation time for each method is derived and performance of each method is evaluated by substituting mobile environmental parameters into the derived theoretical equation (for example, Umezawa et al., “Evaluation of Certificate Validation Method in Mobile Environment”, Denshi Jyoho Tsushin Gakkai Ronbunshi (D) (Journal (D) of the Institute of Electronics, Information and Communication Engineers) (D), J90-D, No. 2, pp. 384-389 (2007-2), referred to as Document 4).

As described above, although it is obviously desirable in validation of a public key certificate that validation be performed at high speed, the time required for validation depends on environmental parameters such as the performance of a service-receiving apparatus, the performance of a server apparatus, communication speed of a network, and the like, and thus a suitable public key certificate validation method differs depending on the environmental parameters.

The above-mentioned conventional techniques (Documents 1, 2 and 3) define the specific public key certificate validation methods. Further, Document 4 evaluates performance of public key certificate validation methods and clarifies that a suitable method differs depending on environment. However, there remains a problem of how to select the best method for a situation requiring validation of a certificate.

### SUMMARY OF THE INVENTION

The present invention has been made considering the above situation, and provides a public key certificate validation system and method suitable for a mobile environment.

The present invention provides a public key certificate validation system in which a public key certificate validation method is dynamically changed depending on environmental parameters when validation of a public key certificate is performed, to realize public key certificate validation suitable for the environment.

In detail, a service receiving apparatus that performs validation of a public key certificate of a service provider apparatus determines a public key certificate validation method on the basis of a combination of the performance of the service receiving apparatus, the performance of a CRL repository apparatus, the performance of a public key certificate validation apparatus, and the performance of a network. The service receiving apparatus performs validation of the public key certificate by the determined method.

Furthermore, a service receiving apparatus that performs validation of a public key certificate of a service provider apparatus requests a method selection apparatus to validate the public key certificate. The method selection apparatus determines a public key certificate validation method on the basis of a combination of the performance of the method selection apparatus, the performance of the CRL repository apparatus, the performance of the public key certificate validation apparatus, and the performance of the network, performs validation of the public key certificate, and notifies a validation result to the service receiving apparatus.

In further detail, the present invention provides a public key certificate validation system comprising: a service provider apparatus that provides a service; a service receiving apparatus that receives the service from the service provider apparatus; one or more CRL repository apparatuses each of which provides revocation information on a public key certificate used for authentication between the service provider apparatus and the service receiving apparatus; one or more public key certificate validation apparatuses each of which judges validity of a public key certificate used for authentication between the service provider apparatus and the service receiving apparatus; one or more networks to which the service provider apparatus, the service receiving apparatus, the CRL repository apparatuses, and the public key certificate validation apparatuses are coupled. The service provider apparatus comprises: a service providing unit for providing its service to the service receiving apparatus; and a communication unit for communicating with the service receiving apparatus. The service receiving apparatus comprises: a public key certificate validation request unit for requesting validation of a public key certificate received from the service provider apparatus; a selection unit for determining a validation method for validation of the public key certificate; and a communication unit for sending and receiving data through the networks. Each public key certificate validation apparatus comprises: a public key certificate validation unit for validating a public key certificate on the basis of a public key certificate validation request received from the service receiving apparatus; and a communication unit for sending and receiving data through the networks. Each CRL repository apparatus comprises: a CRL providing unit for providing a CRL on the basis of a CRL request received from the service receiving apparatus or a public key certificate validation apparatus; and a communication unit for sending and receiving data through the networks.

Further, the service receiving apparatus may further comprise a performance information storage unit for storing the performance of the service receiving apparatus, the public key certificate validation apparatuses, the CRL repository apparatuses and the networks.

Further, each public key certificate validation apparatus may further comprise a performance information storage unit for storing the performance of the public key certificate validation apparatus itself.

Further, each CRL repository apparatus may further comprise a performance information storage unit for storing the CRL repository apparatus itself.

Further, the service receiving apparatus selects for itself a public key certificate validation method. However, validation of a public key certificate may be performed through a method selection apparatus that determines a public key certificate validation method instead of the service receiving apparatus.

According to the present invention, it becomes possible to change a public key certificate validation method depending on environmental parameters, to realize public key certificate validation suitable for environment.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram showing an example of a configuration of a certificate validation system to which a first embodiment of the present invention is applied;

FIG. 2 is a diagram showing an example of a hardware configuration of a service receiving apparatus shown in FIG. 1;

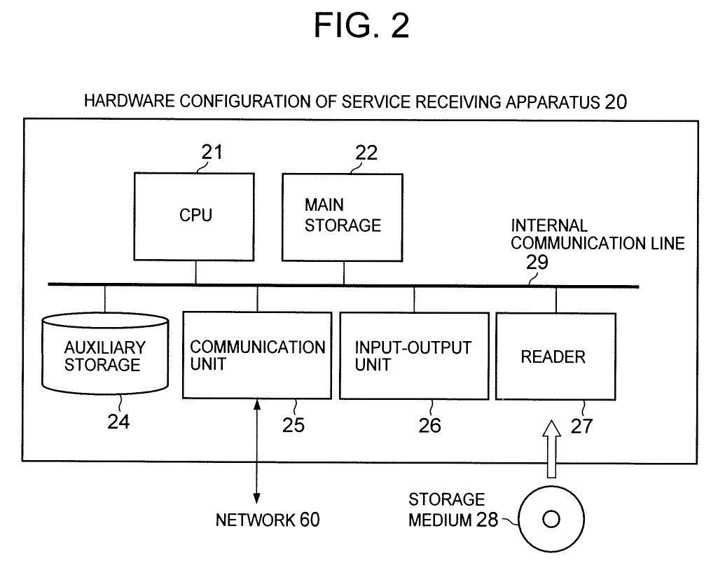

FIG. 3 is a diagram showing examples of data transmission and processing flow of the certificate validation system to which the first embodiment is applied;

FIG. 4 is a diagram showing examples of environmental parameters;

FIG. 5 is a diagram showing an example of a configuration of a certificate validation system to which a second embodiment of the present invention is applied;

FIG. 6 is a diagram showing examples of data transmission and processing flow of the certificate validation system to which the second embodiment is applied; and

FIG. 7 is a diagram showing the calculation formulas disclosed in Document 4.

### DETAILED DESCRIPTION OF THE EMBODIMENTS

Now, an embodiment of the present invention will be described, although this does not restrict the invention.

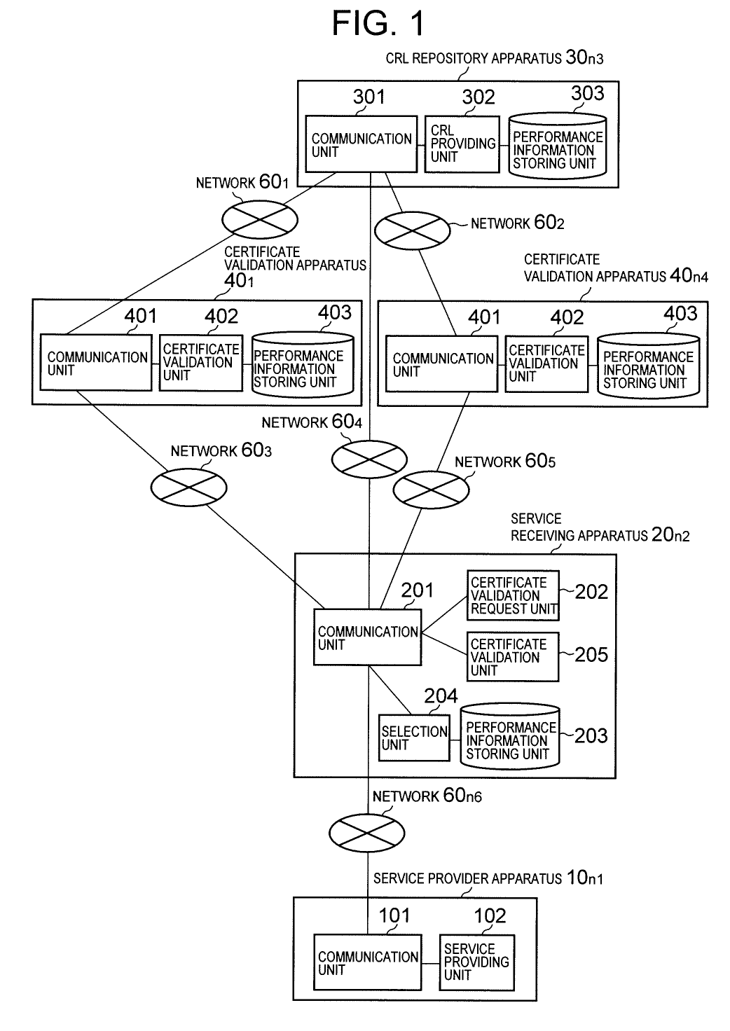

FIG. 1 is a block diagram showing a public key certificate validation system to which an embodiment of the present invention is applied. In the following description, a public key certificate will be simply referred to as a certificate.

As shown in FIG. 1, the certificate validation system of the present embodiment comprises: one or more service provider apparatuses 10₁-10ₙ₁ (hereinafter, also referred to simply as service provider apparatus 10); one or more service receiving apparatuses 20₁-20ₙ₂ (hereinafter, also referred to simply as service receiving apparatus 20); one or more CRL repository apparatuses 30₁-30ₙ₃ (hereinafter, also referred to simply as CRL repository apparatus 30); and one or more certificate validation apparatuses 40₁-40ₙ₄ (hereinafter, also referred to simply as certificate validation apparatus 40), mutually connected with one another via one or more networks 60₁-60ₙ₆ (hereinafter, also referred to simply network 60), such as a cell-phone network or the Internet.

Each service provider apparatus 10 receives a service request from a service receiving apparatus 20. Then, the service provider apparatus 10 and the service receiving apparatus 20 perform authentication processing between them. When the authentication is successful, the service provider apparatus 10 provides its service to the service receiving apparatus 20. In the above-mentioned authentication processing, a certificate held by the service provider apparatus 10 is sent to the service receiving apparatus 20, and then the service receiving apparatus 20 validates the certificate and sends a validation result to the service provider apparatus 10, to finish the authentication processing.

Each service provider apparatus 10 comprises a service providing unit 102 for providing a service, and a communication unit 101 for communication through the network 60.

In authentication processing with a service provider apparatus 10, a service receiving apparatus 20 validates a certificate sent from the service provider apparatus 10, and, if the validation is successful, the service receiving apparatus 20 notifies the service provider apparatus 10 of the result and receives its service. To validate the certificate, the service receiving apparatus 20 determines a certificate validation method on the basis of a combination of the performance of the service receiving apparatus 20, the performance of the CRL repository apparatus 30, the performance of the certificate validation apparatus 40, and the performance of the network 60, and validates the certificate on the basis of the determination.

The performance of the network 60 can be acquired by using published data on the network or by measuring the performance at the time of sending and receiving data.

Each service receiving apparatus 20 comprises: a communication unit 201 for communication through a network 60; a certificate validation unit 205 for validating a certificate received from a service provider apparatus 10; a certificate validation request unit 202 for requesting a certificate validation apparatus 40 to validate a certificate received from a service provider apparatus 10; a selection unit 204 for determining a certificate validation method on the basis of a combination of the performance of the service receiving apparatus 20 itself, the performance of a CRL repository apparatus 30, the performance of the certificate validation apparatus 40, and the performance of the network 60; and a performance information storage unit 203 for storing performance information values that express the performance of the service receiving apparatus 20 itself.

The CRL repository apparatus 30 provides a CRL when the CRL is requested through the network 60.

The CRL repository apparatus 30 comprises: a communication unit 301 for communication through the network 60; a CRL providing unit 302 for providing a CRL; and a performance information storage unit 303 for storing performance information values that express the performance of the CRL repository apparatus 30.

The certificate validation apparatus 40 validates a certificate when validation of the certificate is requested through the network 60, and returns a validation result to the source of the validation request.

The certificate validation apparatus 40 comprises: a communication unit 401 for communication through the network 60, a certificate validation unit 402 for validating a certificate; and a performance information storage unit 403 for storing performance information values that express the performance of the certificate validation apparatus 40.

Each of the networks 60 is a communication network between the service provider apparatuses 10 and the service receiving apparatuses 20, between the service receiving apparatuses 20 and the CRL repository apparatuses 30, between the service receiving apparatuses 20 and the certificate validation apparatuses 40, or between the CRL repository apparatuses 30 and the certificate validation apparatuses 40. The networks 60 may be networks of the same type or networks of different types such as the Internet, dedicated lines, mobile networks, and short range radio communication.

FIG. 29 is a diagram showing a hardware configuration of a service receiving apparatus 20. Each service receiving apparatus 20 can be implemented by an ordinary computer comprising a CPU 21, a main storage 22, an auxiliary storage 24, a communication unit 25, an input-output unit 26, a reader 27 for reading a storage medium 28, and an internal communication line 29 such as a bus connecting the mentioned components.

Also, the service provider apparatuses 10, the CRL repository apparatuses 30, and the certificate validation apparatuses 40 can be each implemented by a hardware configuration similar to that of the service receiving apparatus 20.

A processing flow in the certificate validation system of the present embodiment will be described. In each of the apparatuses constituting the certificate validation system, programs stored in the auxiliary storage 24 of the apparatus are loaded to the main storage 22 and executed by the CPU, to realize the below-described processing units in the apparatus in question. These processing units perform the below-described processing flow. Each program may be stored beforehand in the auxiliary storage 24, or may be introduced through a storage medium or a communication medium (a network, or a carrier wave, or a digital signal propagated through a network) when needed.

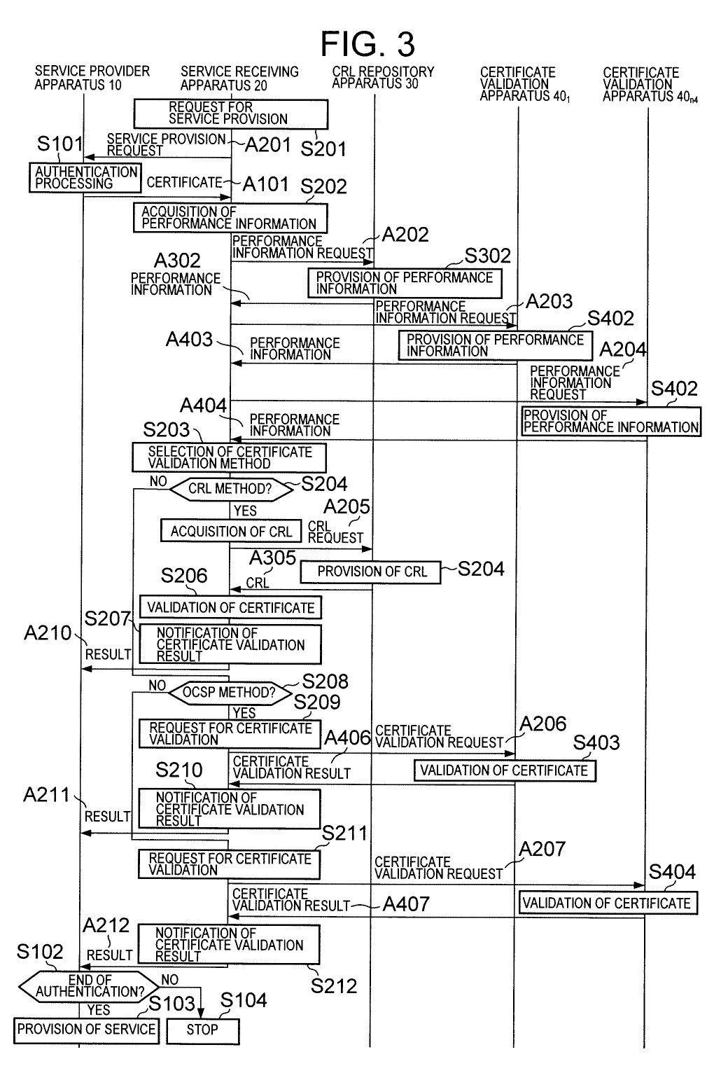

FIG. 3 is a flowchart showing flow in which: a service receiving apparatus 20 requests a service from a service provider apparatus 10; the service provider apparatus 10 sends a certificate to the service receiving apparatus 20 in authentication processing; the service receiving apparatus 20 validates the received certificate and sends a validation result to the service provider apparatus 10; and, when the authentication is finished, the service provider apparatus 10 provides the service.

First, a service receiving apparatus 20 sends a service provision request to a service provider apparatus 10 (Step S201). The service provider apparatus 10 starts authentication processing, and sends a certificate to the service receiving apparatus 20 (Step S101). The service receiving apparatus 20 performs performance information acquisition processing (Step S202). In detail, the service receiving apparatus 20 sends a performance information request (A202) to a CRL repository apparatus 30 in order to acquire performance information that indicates the performance of the CRL repository apparatus 30. In response to the request, the CRL repository apparatus 30 provides the performance information (A302) held in the performance information storage unit 303 of the CRL repository apparatus 30 to the service receiving apparatus 20 (Step S302). In cases where a plurality of CRL repository apparatuses 30 exist, the service receiving apparatus 20 may make a service provision request to a plurality of CRL repository apparatuses 30. Next, the service receiving apparatus 20 sends a performance information request (A203) to a certificate validation apparatus 40 in order to acquire performance information that indicates the performance of the certificate validation apparatus 40. In response to the request, the certificate validation apparatus 40 provides the performance information (A403) held in the performance information storage unit 403 of the certificate validation apparatus 40 to the service receiving apparatus 20 (Step S402). In cases where a plurality of certificate validation apparatuses 40 exist, the service receiving apparatus 20 may send a performance information request to a plurality of certificate validation apparatuses 40.

Next, the service receiving apparatus 20 determines a certificate validation method on the basis of the performance information acquired in the performance information acquisition processing (S202), the performance information held in the performance information storage unit 203 of the service receiving apparatus 20, and environmental parameters such as the network speed and the authentication frequency (Step S203). Calculation formulas used for the determination are known, such as those in Document 4, for example.

In cases where the determined method is a method (hereinafter, referred to as CRL method) in which the service receiving apparatus itself acquires a CRL and performs certificate validation, the service receiving apparatus 20 performs CRL acquisition processing (Step S205). In detail, the service receiving apparatus 20 sends a CRL request (A205) to the CRL repository apparatus 30. The CRL providing unit 302 of the CRL repository apparatus 30 sends the CRL (A305), which it holds, to the service receiving apparatus 20 (Step S204). The service receiving apparatus 20 validates the certificate received from the service provider apparatus 10 by confirming that the received CRL (A305) does not include the information of the certificate (Step S206). Thereafter, the service receiving apparatus 20 notifies the service provider apparatus 10 of the certificate validation result (Step S207).

In cases where the method determined by the service receiving apparatus 20 in the certificate validation method selection (Step S203) is a method (hereinafter, referred to as OCSP method) in which the certificate validation apparatus is requested to perform processing confirming that the CRL does not include the certificate for which validation is to be performed, the service receiving apparatus 20 performs certificate validation request processing (Step S209). In detail, the service receiving apparatus 20 sends a certificate validation request (A206) to the certificate validation apparatus 40. The certificate validation unit 402 of the certificate validation apparatus 40 then acquires the CRL from the CRL repository apparatus 30, performs certification validation on the basis of the CRL and the certificate validation request (A206) (Step S403), and sends a certification validation result (A406) to the service receiving apparatus 20. Thereafter, the service receiving apparatus 20 notifies the service provider apparatus 10 of the certificate validation result (Step S210).

In cases where the method determined by the service receiving apparatus 20 in the certificate validation method selection (Step S203) is a method (hereinafter, referred to as CVS method) in which the certificate validation apparatus (CVS) is requested to perform validation of the signature of a certificate, confirmation of the expiration date, confirmation of revocation, and the like, then the service receiving apparatus performs certificate validation request processing (Step S211). In detail, the service receiving apparatus 20 sends a certificate validation request (A207) to the certificate validation apparatus 40. Then, the certificate validation unit 402 of the certificate validation apparatus 40 performs validation of the signature of the certificate and confirmation of the expiration date of the certificate. Further, the certificate validation unit 402 acquires the CRL from the CRL repository apparatus 30 and performs certification validation on the basis of the received CRL and the certificate validation request (A207) (Step S404). Then, a certificate validation result (A407) is sent to the service receiving apparatus 20. Thereafter, the service receiving apparatus 20 notifies the service provider apparatus 10 of the certificate validation result (Step S212).

The service provider apparatus 10 receives the certificate validation result from the service receiving apparatus 20. When the authentication processing is finished, then the service provider apparatus 10 provides its service (Step S103). Otherwise, the service provider apparatus 10 cancels the service (Step S104).

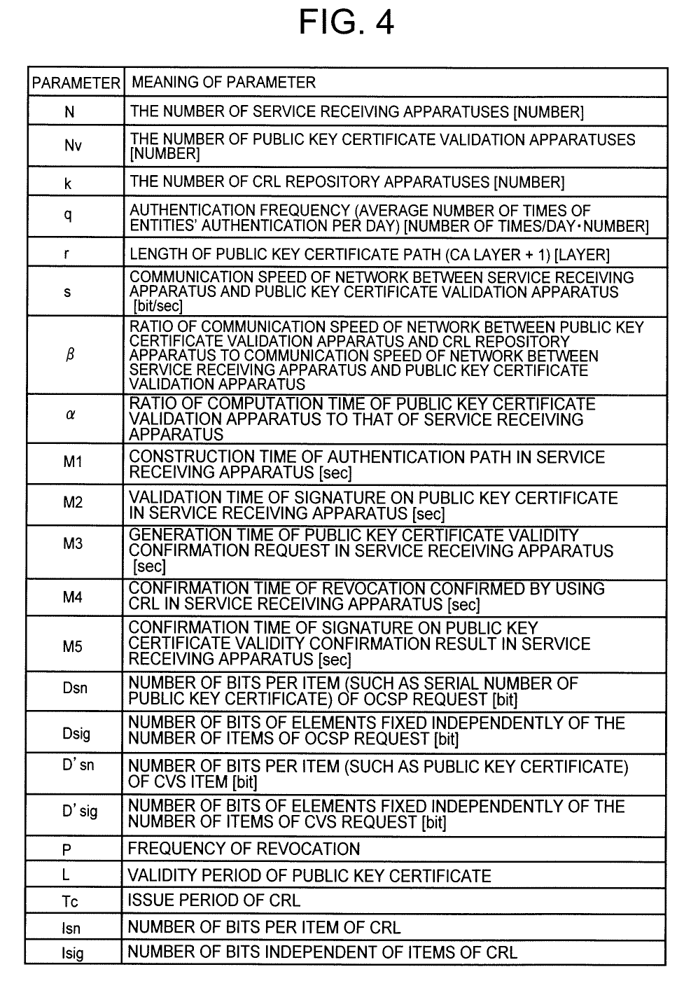

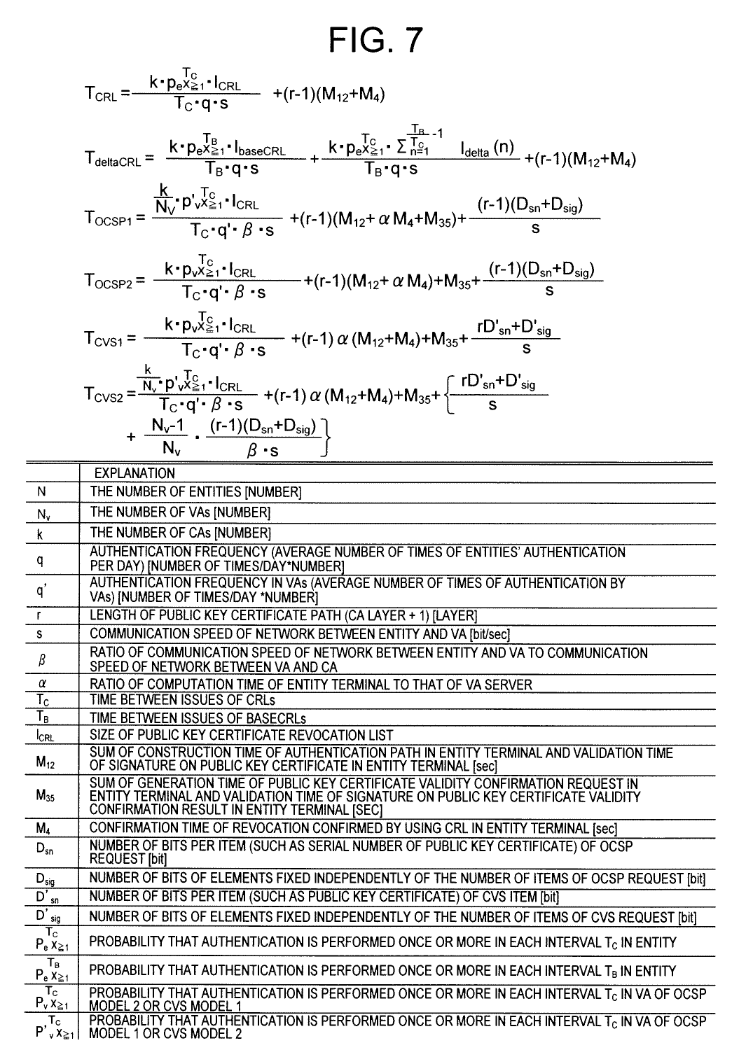

FIG. 4 shows examples of the performance information that the service receiving apparatus 20 receives from the CRL repository apparatus 30 and the certificate validation apparatus 40, the performance information held by the performance information storage unit 203 of the service receiving apparatus 20, and the environmental parameters such as network speed and authentication frequency. The service receiving apparatus 20 determines a certificate validation method on the basis of these values by using the calculation formulas disclosed in Document 4 (See FIG. 7).

When the service receiving apparatus acquires performance information, the service receiving apparatus also acquires parameters required for absolute evaluation or relative evaluation. Furthermore, parameter values that are representative in the current environment may be set beforehand, and used in place of a parameter that cannot be acquired for some reason.

The present invention is not limited to the above-described embodiment, and various modifications are possible within the scope of the invention.

For example, in FIG. 3, the certificate (A101) is sent, in the authentication processing (Step S101) of the service provider apparatus 10. However, it is possible that, as other pieces of authentication information, signature data encrypted with a secret key of the service provider apparatus 10 are sent together with signature object data, and the service receiving apparatus 20 validates the signature data by using a public key included in the received certificate (A101).

Further, in FIG. 3, the service receiving apparatus 20 acquires the performance information from the CRL repository apparatus 30 and the certificate validation apparatus 40 (Step S202). However, in cases where the service receiving apparatus 20 has received the performance information in advance, the performance information acquisition processing can be omitted.

Further, in the performance information providing processing (Step S302) of the CRL repository apparatus 30 and the performance information providing processing (Step S402) of the certificate validation apparatus 40, the performance information held in the performance information storage unit is provided. However, when the CRL repository apparatus 30 and the certificate validation apparatus 40 can dynamically acquire and provide their own performance information, then it is not necessary to provide the performance information held statically in their performance information storage units.

Furthermore, apparatus and network performance information, which is close to that of the above-described apparatuses and network and can substitute for those apparatuses and network, may be acquired as needed or in advance and used in place thereof.

Further, in the CRL providing processing (Step S204) of the CRL repository apparatus 30, the CRL is sent to the service receiving apparatus 20. However, it is possible that a signature on the CRL is sent together with the CRL, and the service receiving apparatus 20 validates the signature on the CRL to confirm the validity of the CRL.

Further, after the certificate validation processing (Step S403) of the certificate validation apparatus, the certificate validation result is sent to the service receiving apparatus 20. However, it is possible that a signature on a certificate validation result is sent together with the certificate validation result, and the service receiving apparatus 20 validates the signature on the certificate validation result to confirm the validity of the certificate validation result.

In the first embodiment, the certificate validation apparatus 40 for realizing the OCSP method and the certificate validation apparatus 40 for realizing the CVS method are mentioned as examples. However, various kinds of certificate validation apparatuses may exist according to different certificate validation methods.

Further, FIG. 3 shows the flow in which the service receiving apparatus 20 validates the certificate A101 sent from the service provider apparatus 10 to the service receiving apparatus 20. However, it is possible that the service receiving apparatus 20 sends a certificate to the service provider apparatus 10 and the service provider apparatus 10 validates the certificate. In that case, the service provider apparatus 10 has component units corresponding to the component units of the service receiving apparatus 20, i.e. the certificate validation request unit 202, the certificate validation unit 205, the selection unit 204, and the performance information storage unit 203.

Next, a second embodiment of the present invention will be described. Further, this does not restrict the invention.

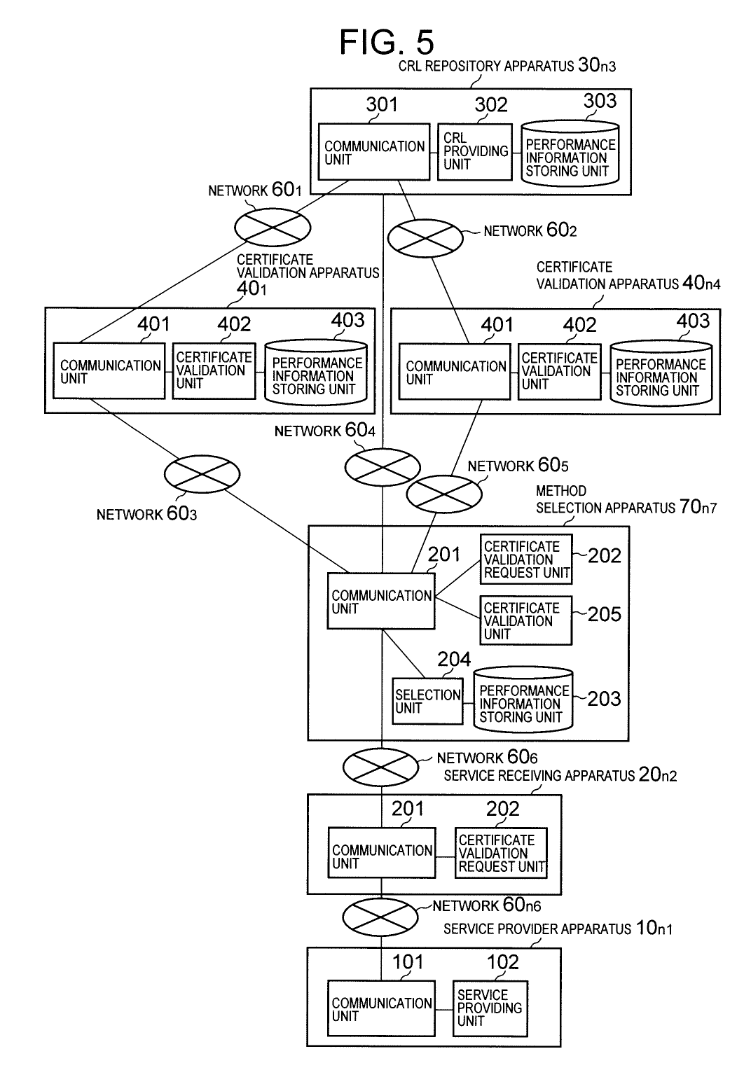

As shown in FIG. 5, a certificate validation system of the present embodiment comprises: one or more service provider apparatuses 10₁-10ₙ₁ (hereinafter, also referred to simply as service provider apparatus 10); one or more service receiving apparatuses 20₁-20ₙ₂ (hereinafter, also referred to simply as service receiving apparatus 20); one or more method selection apparatuses 70₁-70ₙ₇ (hereinafter, also referred to simply as method selection apparatus 70); one or more CRL repository apparatuses 30₁-30ₙ₃ (hereinafter, also referred to simply as CRL repository apparatus 30); and one or more certificate validation apparatuses 40₁-40ₙ₄ (hereinafter, also referred to as certificate validation apparatus 40), mutually connected with one another via one or more networks 60₁-60ₙ₆ (hereinafter, also referred to simply network 60), such as a cell-phone network or the Internet.

Each service provider apparatus 10 receives a service request from a service receiving apparatus 20. The service provider apparatus 10 and the service receiving apparatus 20 then perform authentication processing between them. If the authentication processing is successful, the service provider apparatus 10 provides its service to the service receiving apparatus 20.

In the above authentication processing, a certificate held by the service provider apparatus 10 is sent to the service receiving apparatus 20, and the service receiving apparatus 20 sends the certificate to a method selection apparatus 70. The method selection apparatus 70 acquires a result of validating the certificate, and sends the validation result to the service receiving apparatus 20. The service receiving apparatus 20 sends the validation result to the service provider apparatus 10, to finish the authentication processing.

Operation of each service provider apparatus 10 is similar to that in the first embodiment.

In the first embodiment, each CRL repository apparatus 30 sends a CRL to a service receiving apparatus 20 or a certificate validation apparatus 40. The present embodiment is different in that each CRL repository apparatus sends a CRL to a method selection apparatus 70 or a certificate validation apparatus 40. The other operations of each CRL repository apparatus are similar to those in the first embodiment.

In the first embodiment, each certificate validation apparatus 40 receives a certificate validation request from a service receiving apparatus 20, and sends a validation result to that service receiving apparatus 20. The present embodiment is different from the first embodiment in that each certificate validation apparatus 40 receives a certificate validation request from a method selection apparatus 70 and sends a validation result to that method selection apparatus 70. The other operations of each certificate validation apparatus 40 are similar to those in the first embodiment.

Each service receiving apparatus 20 comprises: a communication unit 201 for communication through a network 60; and a certificate validation request unit 202 for requesting a method selection apparatus 70 to validate a certificate received from a service provider apparatus 10.

Each method selection apparatus 70 comprises: a communication unit 201 for communication through a network 60; a certificate validation unit 205 for validating a certificate received from a service receiving apparatus 20; a certificate validation request unit 202 for requesting a certificate validation apparatus 40 to validate the certificate received from the service receiving apparatus 20; a selection unit 204 for determining a certificate validation method on the basis of a combination of the performance of the method selection apparatus 70 itself, the performance of a CRL repository apparatus 30, the performance of the certificate validation apparatus 40, and the performance of the network 60; and a performance information storage unit 203 for storing performance information values that express the performance of the method selection apparatus 70 itself.

The networks 60 are networks between the service provider apparatuses 10 and the service receiving apparatuses 20, between the service receiving apparatuses 20 and the method selection apparatuses 70, between the method selection apparatuses 70 and the CRL repository apparatuses 30, between the method selection apparatuses 70 and the certificate validation apparatuses 40, and between the CRL repository apparatuses 30 and the certificate validation apparatuses 40. The networks 60 may be networks of different types such as Internet, dedicated lines, mobile networks, short range radio communication and the like, or may be networks of the same type.

Processing flow in the certificate validation system of the second embodiment will be described. In each of the apparatuses constituting the certificate validation system, programs stored in the auxiliary storage 24 of the apparatus are loaded to the main storage 22 and executed by the CPU, to realize the below-described processing units in the apparatus in question. The processing flow described below is performed by these processing units. Each program may be stored beforehand in the auxiliary storage 24, or may be introduced through a storage medium or a communication medium (a network, a carrier wave, or a digital signal propagated through a network) when needed.

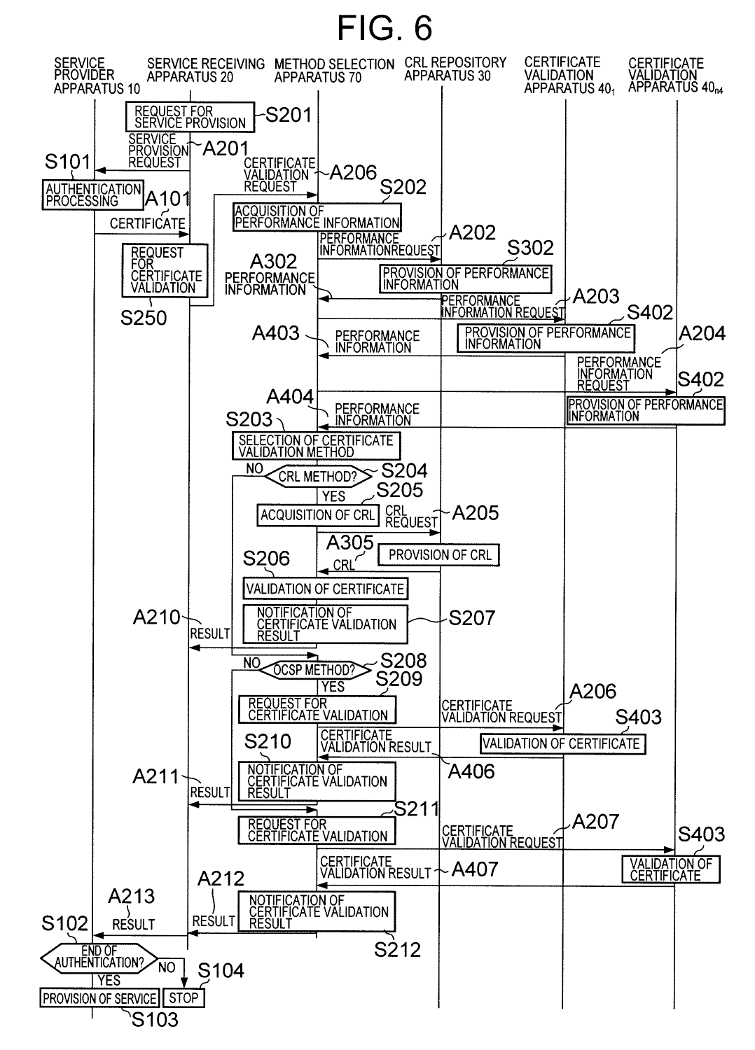

FIG. 6 is a flowchart showing flow in which: a service receiving apparatus 20 requests a service from a service provider apparatus 10; the service provider apparatus 10 sends a certificate to the service receiving apparatus 20, in authentication processing; the service receiving apparatus 20 validates the received certificate and sends a validation result to the service provider apparatus 10; and, when the authentication is finished, the service provider apparatus 10 provides its service.

Unlike the processing flow in the certificate validation system of the first embodiment shown in FIG. 3, a method selection apparatus 70 determines a certificate validation method in the second embodiment while the service receiving apparatus 20 determines a certificate validation method in the first embodiment.

Operation of the service provider apparatus 10 is similar to that of the first embodiment.

In the first embodiment, the CRL repository apparatus 30 operates to provide a CRL to the service receiving apparatus 20 or the certificate validation apparatus 40. The present embodiment is different from the first embodiment in that the CRL repository apparatus 30 provides a CRL to the method selection apparatus 70 or the certificate validation apparatus 40. The other operations of the CRL repository apparatus 30 are similar to those in the first embodiment.

In the first embodiment, the certificate validation apparatus 40 operates to receive a certificate validation request from the service receiving apparatus 20 and to send a validation result to the service receiving apparatus 20. The present embodiment is different from the first embodiment in that the certificate validation apparatus 40 receives a certificate validation request from the method selection apparatus 70 and sends a validation result to the method selection apparatus 70. The other operations of the certificate validation apparatus 40 are similar to those of the first embodiment.

Operation of a service receiving apparatus 20 and a method selection apparatus 70 will be described.

First, a service receiving apparatus 20 sends a service provision request to a service provider apparatus 10 (Step S201). The service provider apparatus 10 starts authentication processing, and sends a certificate to the service receiving apparatus 20 (Step S101). The service receiving apparatus 20 performs certificate validation request processing (Step S250), and sends a certificate validation request (A206) to a method selection apparatus 70. The method selection apparatus 70 receives the certificate validation request, and performs certificate validation processing. Processing from Step S202 to Step S212 is similar to that in the operation flow of the service receiving apparatus 20 in the first embodiment. The service receiving apparatus 20 receives a certificate validation result, and notifies the service provider apparatus to the service provider apparatus 10 (Step S213).

The service provider apparatus 10 receives the certificate validation result from the service receiving apparatus 20, and provides its service when the authentication processing is finished (Step S103). Otherwise, the service provider apparatus 10 cancels its service (Step S104).

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A public key certificate validation system comprising a service provider apparatus that provides a service and a service receiving apparatus that receives the service from the service provider apparatus, the public key certificate validation system being connected through a network to a validation information providing system that provides validation information for a public key certificate, wherein:
the service provider apparatus comprises a service providing unit which provides the service to the service receiving apparatus;
the service receiving apparatus comprises: a validation request unit which requests the validation information providing system to validate a public key certificate received in response to a service provision request that was requested of the service provider apparatus; and a selection unit which selects a validation method for validating the public key certificate;
the validation request unit of the service receiving apparatus sends a service provision request to the service provider apparatus, and receives a public key certificate of the service provider apparatus from the service provider apparatus in response to the service provision request; and
the selection unit:
selects a validation method suitable for validating the received public key certificate, according to a predetermined selection criterion, when the service provision request is sent;
acquires a validation result of validation performed according to the selected validation method, using the validation information providing system; and
sends the acquired validation result to the service provider apparatus.

2. A public key certificate validation system of claim 1, wherein:
the validation result is one of: validation information provided by the validation information providing system, and a result of processing in the service receiving apparatus based on the validation information.

3. A public key certificate validation system of claim 2, wherein:
the validation information providing system comprises at least one CRL repository apparatus and at least one public key certificate validation apparatus for judging validity of a public key certificate;
the selection unit selects, in the selection, a validation entity that validates the public key certificate;
in cases in which the selected validation entity is the service receiving apparatus itself, the service receiving apparatus sends a CRL request to the at least one CRL repository apparatus, and receives a CRL as the validation information from the at least one CRL repository apparatus, and the validation request unit validates the received public key certificate based on the received CRL and sends a validation result to the service provider apparatus; and
in cases in which the selected validation entity is the at least one public key certificate validation apparatus, the service receiving apparatus sends a public key certificate validity judgment request to the at least one public key certificate validation apparatus, receives a validity judgment result as the validation information from the at least one public key certificate validation apparatus, generates a validation result based on the received validation information, and sends the validation result to the service provider apparatus.

4. A public key certificate validation system of claim 3, wherein:
the selection criterion is determined based on performance of at least one of the service receiving apparatus, the at least one CRL repository apparatus, the at least one public key certificate validation apparatus, and the network.

5. A public key certificate validation system of claim 4, wherein:
the selection unit of the service receiving apparatus acquires the performance in advance or at reception of a validation request.

6. A public key certificate validation system of claim 4, wherein:
the selection unit of the service receiving apparatus acquires at least a portion of performance information indicating the performance, from one of: the at least one CRL repository apparatus and the at least one public key certificate validation apparatus.

7. A public key certificate validation system of claim 6, wherein:
the service receiving apparatus comprises a performance information storage unit for storing the performance information;
the selection unit of the service receiving unit acquires the performance information independently of the reception of the public key certificate that is to be validated, and stores the performance information in the performance information storage unit; and
the selection unit refers to the performance information held in the performance information storage unit.

8. A public key certificate validation system of claim 3, wherein:
the public key certificate validation system includes, as public key certificate validation apparatuses, a plurality of public key certificate validation apparatuses performing validation based on methods different from one another; and
in cases in which the selected validation entity is a public key certificate validation apparatus, the selection unit further selects a validation method to make a request, and requests a public key certificate validation apparatus that performs validation according to the selected validation method, to perform validation.

9. A public key certificate validation system of claim 8, wherein:
the plurality of public key certificate validation apparatuses include a public key certificate validation apparatus that performs validation according to OCSP (Online Certificate Status Protocol) method and a public key certificate validation apparatus that performs validation according to a method using a CVS (certificate validation server).

10. A public key certificate validation system of claim 5, wherein:
the performance is acquired by measurement by the selection unit, or by acquiring performance of at least one of a network or an apparatus that is different from and can substitute for the service receiving apparatus, the at least one CRL repository apparatus, the at least one public key certificate validation apparatus, and the network.
